(19) United States
(12) Patent Application Publication
(10) Pub. No.: US 2014/0352556 A1
(43) Pub. Date: Dec. 4, 2014

(54) PEELING DEVICE

(71) Applicant: EKKO HOLDING ApS, Vejle (DK)

(72) Inventor: Rune Särs, Tolby (FI)

(21) Appl. No.: 14/372,856

(22) PCT Filed: Jan. 18, 2013
(86) PCT No.: PCT/FI2013/050054

§ 371 Date: Jul. 17, 2014

(30) Foreign Application Priority Data
Jan. 20, 2012 (FI) 20125068

(51) Int. Cl. A23N 7/02

(52) U.S. Cl. CPC A23N 7/02
USPC 99/591

(57) ABSTRACT

The present invention relates to a peeling device (1) comprising rod-like peeling elements (10) comprising at least one cutting means(4)on at least a part of an outer surface thereof and being attached to means for rotating the peeling element (10) about a rotation axis (3).The peeling elements (10) are arranged in a circumferential arrangement to form an elongated peeling drum (7), wherein each individual peeling element (10) rotates about a first rotation axis (3) and the drum rotates about a second rotation axis (8).

### FIELD OF THE INVENTION

The present invention relates to a peeling device for peeling peelable products, such as potatoes, and a peeling drum of such a peeling device.

### BACKGROUND OF THE INVENTION

It is previously known to utilize cutting means, such as knives in peeling devices to peel a product. However, a drawback with many of such known knife peelers is that the knives are sensitive to sand and other impurities that may be present when potatoes, for example, are peeled. When a product is peeled in one step using such a knife peeler, the blades become blunt quite rapidly and thus have to be replaced.

To avoid constant replacement of blades in a knife peeler, it is known to carry out the peeling with two different peeling devices of which the latter is a knife peeler. In this case the first peeling device is a peeling element having a rough scraping surface. The rough scraping surface of the peeling element provides a first peeling step. In the first peeling step, impurities, such as sand, are removed. After the first peeling step, the product is conveyed to a second peeling device, which is a knife peeler. The knife peeler thus finishes the peeling of the product without its blades coming into contact with sand or the like impurities. The drawback in this known solution is, however, that the peeling of a product requires two different peeling devices, which increases the costs of the peeling apparatus and, moreover, the peeling apparatus requires a relatively large space.

Furthermore, a rod-like peeling element rotatable about a rotation axis and comprising on an outer surface a first part comprising a rough scraping surface, a second part comprising at least one cutting means and a peeling device comprising at least a pair of such adjacent peeling elements is known from EP 1 123 663.

Also, an apparatus for peeling fruits or vegetables with a rotatable drum comprising rotatable shafts having abrasive material on their exterior surface is known from U.S. Pat. No. 3,134,413.

### BRIEF DESCRIPTION OF THE INVENTION

A new peeling device and peeling drum has now been developed. The solution is characterised by what is stated in the independent claims. Preferred embodiments of the invention are set forth in the dependent claims.

According to an aspect of the invention, a peeling drum comprises multiple peeling elements having a rod-like shape and being attached to means for rotating the peeling elements about first rotation axes, at least some of the peeling elements comprise peeling means along at least a part of their outer surface, wherein the peeling means of at least some of the peeling elements comprise at least one cutting means, and the peeling elements have been arranged in a circumferential arrangement to form an elongated drum, wherein the drum is rotatable about a second rotation axis, and wherein at least one peeling element comprises cutting means.

The present invention provides several advantages which will become apparent from the detailed description. The invention is based on the idea of arranging multiple rod-like peeling elements comprising at least one cutting means to form an elongated drum, wherein each peeling element is arranged to be rotatable about an axis, i.e. one of the first rotation axes. The elongated drum formed by the plurality of peeling elements is arranged to be rotatable about a second rotation axis. A peeling device may be provided with such a peeling drum. This kind of a peeling device enables a very high capacity knife peeler to be formed. Additionally, in this kind of a peeling device the wear of the peeling elements is very even and the wear is distributed the high number of peeling elements, which enables long service intervals and, thus, low maintenance costs.

According to an embodiment, at least some of the peeling elements comprise a first and a second part of the outer surface of the peeling element, wherein the first part of the outer surface of the peeling element comprises a rough scraping surface and the second part of the outer surface of the peeling element comprises said at least one cutting means. Such a peeling element allows a product to be peeled in the same peeling device in such a way that the rough scraping surface of the peeling element starts the peeling and the cutting means of the peeling element finishes the peeling. When peeling is started with the rough scraping surface, the cutting means does not come into contact with sand or the like impurities. Thus, this embodiment can further improve the service intervals and reduce the need of changing the peeling elements. Additionally, a reduction in the cost of the peeling apparatus and the space required by it can be achieved, since they allow a product to be peeled in a single peeling device.

In a second embodiment, the peeling drum comprises means for moving a peelable product along said peeling elements from a first end of the peeling elements towards a second end (6) of the peeling elements. This allows the peeling device to be made entirely automatic, i.e. it is capable of receiving a peelable product from an inlet, peeling the product and moving the ready-peeled product to an outlet.

Further embodiments of the peeling device are disclosed in the dependent claims.

### BRIEF DESCRIPTION OF FIGURES

Some embodiments of the invention will now be described in greater detail by means of some preferred embodiments and with reference to the attached drawings, in which

FIG. 1 shows a schematic view of a known peeling device,

FIGS. 2a and 2b show two different embodiments of peeling elements,

FIGS. 3a and 3b show an embodiment of a peeling drum from one end and from the side, respectively, and

FIG. 4 shows schematically an embodiment of the peeling device of the invention.

### DETAILED DESCRIPTION OF AN EMBODIMENT OF THE INVENTION

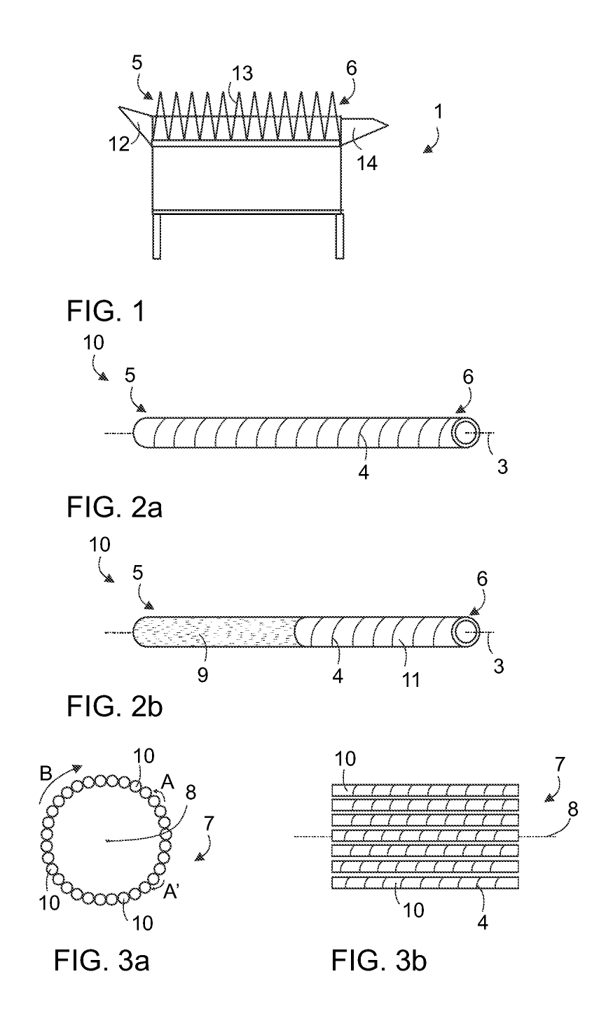

FIG. 1 shows a schematic view of the basic working principle of a peeling device 1 known from EP 1 123663, for example. The peeling device 1 comprises an inlet 12 where the products (e.g. potatoes) to be peeled are applied. The products are disposed above at least one pair of rotating peeling elements (not shown in FIG. 1) at a first end 5 of the peeling elements. The peeling device further comprises a worm conveyor 13 arranged in the vicinity of the surface of the peeling elements. During peeling, the worm conveyor 13 rotates in a direction that makes the products move from the inlet 12 towards the outlet 14 at a second end 6 of the peeling elements. Finally the worm conveyor 13 discharges the ready-peeled products at the outlet 14 of the peeling device. For the sake of clarity, the peeling device 1 in FIG. 1 is shown without the frame part that covers the worm conveyor 13 and the peeling elements 10 (not shown) on which the peelable products are applied.

FIGS. 2a and 2b show two embodiments of a peeling element 10. The peeling element 10 is preferably spoke-shaped. When used for peeling of a product, the peeling element 10 is rotatable about a rotation axis 3, which in FIGS. 1a and 1b coincides with the mid axis of the rod-like element. The peeling element 10 may be rotatable in a direction A, A′ or in either direction.

In FIG. 2a, the peeling element comprises on at least a part of the outer surfaces of the peeling element 10 peeling means 4, wherein on at least a part of the outer surface the peeling means comprises at least one cutting means 4. The peeling element 10 shown in FIG. 2a comprises cutting means 4 along substantially the whole length of its outer surface. In other embodiments, the peeling element 10 may have cutting means 4 along a part of its surface only.

In FIG. 2b, at a first end 5 of the peeling element, the outer surface of the peeling element comprises a rough scraping surface. In some embodiments, the scraping surface may be composed of abrasive material, like carborundum. A second end 6 of the peeling element 10 comprises at least one cutting means 4.

In different embodiments, the cutting means 4 may be implemented, for example, by one or more grooves milled in the outer surface of the peeling element 10, the edges of the groove providing the cutting means 4. An alternative is that only the knife of the cutting means projects from the surface of the peeling element, i.e. material is removed from the surface of the peeling element between the knife of the cutting means such that only the blade projects from the surface of the peeling element.

For the sake of clarity, FIGS. 2a and 2b only show one helical cutting means 4 extending in a direction substantially different from the direction of the rotation axis 3 of the peeling element. In practice, the number of helical cutting means may be larger and the cutting means may be arranged substantially more densely in the longitudinal direction of the peeling element. In different embodiments the cutting means may also be arranged differently or they may have a different shape or form.

A peeling element 10, like the one described in FIG. 2b, may be composed of only a single part that is so processed that its first end 5 is provided with a rough scraping surface of e.g. carborundum and its second end 6 is provided with at least one cutting means 4. Alternatively, the peeling element may be composed of two separate elements coupled together, the outer surface of one element comprising the rough scraping surface and the other element comprising a cutting means. Such a construction allows continuous use of the part comprising the rough scraping surface, even though the part comprising the cutting means is replaced (e.g. when it has become blunt).

The length of the carborundum-covered part of the peeling element 10 may also differ from the length of the part comprising the cutting means. This allows the relationship between peeling the product by scraping and peeling the product with knives to be changed.

The peeling elements 10 shown in FIGS. 2a and 2b are hollow, but in some other embodiments at least one or all peeling elements 10 might not be hollow. The peeling element 10 may be associated with a shaft that is longer than the peeling element, thus the shaft may project from both ends of the peeling element. The projecting parts of the shaft may be coupled to the means that are utilized for rotating the peeling element. In some embodiments, the peeling element 10 may be composed of two or more separate parts, e.g. one comprising an abrasive surface and the other comprising cutting means, like knives, that may be coupled to one another in any known manner, for example by screwing them on a common shaft. In some further embodiments, there may not be any shafts associated with the peeling elements 10, but the peeling elements 10 may be coupled to the peeling device 1 in some other way, like using bearings provided inside or outside the peeling elements 10. The diameter of the peeling element 10 may be about 90 mm, for example.

A peeling device 1 that has e.g. the basic working principle described in connection with FIG. 1 can be provided with a peeling drum 7. FIGS. 3a and 3b show an embodiment of such a peeling drum 7 from one end and from the side, respectively. The peeling device 1 comprising the peeling drum 7 such as the one of FIGS. 3a and 3b can thus utilize a plurality of the peeling elements 10 (only some of which are provided with reference numbers in the figures for the sake of clarity) described in connection with FIG. 2a or 2b, or a combination thereof. The peeling elements 10 have been arranged in a circumferential arrangement to form an elongated peeling drum 7, wherein the peeling drum 7 is rotatable about a second rotation axis 8 in a direction B.

Thus, in the peeling device 1, the products can be fed inside the peeling drum 7 from an inlet 12 at a first end 5 of the peeling elements 10. The peeling device 1 may then comprise means for 13 for moving a peelable product along the peeling elements 10 from the first end 5 of the peeling elements towards a second end 6 of the peeling elements. In some embodiments, the means for moving a peelable product along the peeling elements 10 may comprise a conveyor, e.g. a worm conveyor 13 such as the one shown in FIG. 1, provided within the peeling drum 7 to convey products in a controlled manner and pace through the peeling drum 7 to an outlet 14 at the second end 6 of the peeling elements. Thus, each peeling element 10, the peeling drum 7 as a whole and the worm conveyor 13 may be rotatable separately providing a very good control over the process. In other embodiments, there may be no conveyor, but the products may be moved e.g. simply by utilizing gravity and the capacity of the peeling device per time unit may be adjusted by other means known as such.

The peeling elements 10 in FIGS. 3a and 3b may be rotatable at different speeds, e.g. ca. 1,400 rpm and 200 rpm. In different embodiments all the peeling elements 10 may also be rotatable at substantially equal speeds or more different rotating speeds may be utilised. In different embodiments, all the peeling elements 10 may be rotatable in the same direction A or some of the peeling elements 10 may be rotatable in an opposite direction A′. In embodiments, in which all the peeling elements 10 are rotatable in a same direction A or A′, the rotating direction A, A′ of the peeling elements 10 and the rotation direction B of the peeling drum 7 may be either different or the same. Thus, the peeling elements 10 and the peeling drum 7 may be rotatable in same or in opposite rotating direction.

In different embodiments, other types of peeling elements than the types shown in FIGS. 2a and 2b may be used in such a peeling drum 7, as long as at least some of the peeling elements comprise peeling means along at least a part of their outer surface, wherein the peeling means of at least some of the peeling elements 10 comprise at least one cutting means 4. Preferably, at least one peeling element 10 may comprise cutting means 4 along substantially the whole length of its outer surface, and more preferably all or substantially all peeling elements 10 may comprise cutting means 4 along substantially the whole length of their outer surface. Increasing the outer surface area of the peeling elements 10 comprising cutting means 4 in the peeling drum 7 of the peeling device can increase the potential capacity of the peeling device 1 and improve the surface quality and shelf life of the peeled products.

In some embodiments, the peeling elements 10 in the peeling drum 7 may be provided with weights provided at the center and/or the perimeter of the peeling element to balance the rolling of the peeling drum. In some embodiments, the weights may be provided at or in the vicinity of the first end 5 and the second end 6 of the peeling element. In different embodiments, the weights may be separate structural parts attached to the peeling elements 10 by any suitable means known as such, or the peeling elements 10 may be formed to be heavier on these areas to achieve more balanced rolling of the peeling elements 10 and the peeling drum 7 as a whole. This way a more reliable function of the peeling drum can be achieved and the wear of the structural parts of the peeling device can be further slowed down, thus increasing the maintenance intervals.

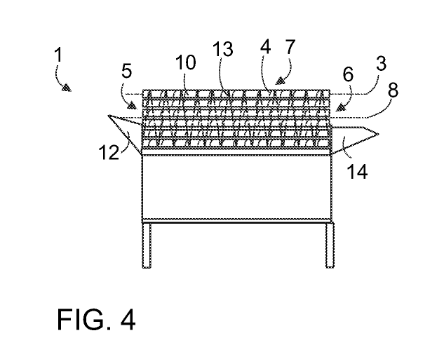

FIG. 4 shows schematically an embodiment of the peeling device 1 of the invention. For the sake of clarity, the peeling device 1 in FIG. 4, just as the one in FIG. 1, is shown without the frame part that in this case would cover the peeling drum 7. The peeling device 1 shown in the figure comprises a peeling drum 7 comprising multiple peeling elements 10 (only some of which have reference numbers in FIG. 4 for the sake of clarity) having a rod-like shape and being attached to means for rotating the peeling elements 10 about first rotation axes 3 (only one of which is shown in the figure). At least some of these peeling elements 10 may comprise peeling means along at least a part of their outer surface, wherein the peeling means of at least some of the peeling elements 10 may comprise at least one cutting means 4. The peeling elements 10 may be arranged in a circumferential arrangement to form an elongated peeling drum 7, wherein the drum is rotatable about a second rotation axis 8.

In different embodiments, the peeling elements 10 may comprise grooves whose edges provide the cutting means 4. In at least one peeling element 10 the cutting means 4 may extend in a direction that is substantially different from the direction of the rotation axis 3.

In further embodiments, at least some of the said peeling elements 10 may comprise a first and a second part of the outer surface of the peeling element, wherein the first part 9 of the outer surface of the peeling element comprises a rough scraping surface and the second part 11 of the outer surface of the peeling element comprises said at least one cutting means 4. The first part 9 and the second part 11 may be arranged in the longitudinal direction of the peeling element 10, the first part 9 being arranged at the first end 5 of the peeling element 10 and the second part 11 being arranged at the second end 6. In different embodiments the rough scraping surface may be composed of abrasive material, such as carborundum.

In further some embodiments, the peeling drum 7 may comprise means for moving a peelable product along said peeling elements 10 from a first end 5 of the peeling elements towards a second end 6 of the peeling elements. These means for moving a peelable product may comprise a worm conveyor 13, for example.

A peeling device 1 comprising a peeling drum 7 as described above can provide a surprisingly high capacity in terms of kilograms of products peeled in an hour. Another great benefit of such a peeling device 1 is that the service intervals can be considerably extended as the high number of peeling elements 10 and the rotation of both the peeling elements 10 and the peeling drum 7 separately provides a very even wear of the cutting means 4, which benefit is even more emphasized if the combined peeling elements 10, such as the ones shown in FIG. 2b, are used to remove residues and outer skin of the products. Additional benefits of such a peeling device 1 include the good quality and natural shape of the peeled products, and a very wide range of products, from small potatoes to long products, like carrots, and to very hard products, may be peeled in the same peeling device 1.

It is to be understood that the above description and the figures are only intended to elucidate a preferred embodiment of the invention. They are schematic representations of the main working principles and features that are relevant for explaining the inventive solution, not representations of any actual machines or components as such. Consequently, the embodiments of the present invention may vary within the scope of the attached claims.

1. A peeling drum comprising:
multiple peeling elements (10) having a rod-like shape and being attached to means for rotating the peeling elements (10) about first rotation axes (3), at least some of the peeling elements comprising peeling means along at least a part of their outer surface, wherein the peeling means of at least some of the peeling elements (10) comprise at least one cutting means (4),characterized in that
the peeling elements (10) have been arranged in a circumferential arrangement to form an elongated peeling drum (7), wherein the peeling drum (7) is rotatable about a second rotation axis (8), and
wherein at least one peeling element (10) comprises cutting means (4).

2. A peeling drum as claimed in claim 1, characterized in that said peeling elements comprise grooves whose edges provide said cutting means (4).

3. A peeling drum as claimed in claim 1 or 2, characterized in that at least one peeling element (10) comprises a cutting means (4) extending in a direction that is substantially different from the direction of said rotation axis (3).

4. A peeling drum as claimed in any of the claims 1 to 3, characterized in that at least some of the peeling elements (10) comprise a first and a second part of the outer surface of the peeling element, wherein the first part of the outer surface of the peeling element comprises a rough scraping surface and the second part of the outer surface of the peeling element comprises said at least one cutting means (4).

5. A peeling drum as claimed in any of the claims 1 to 3, characterized in that at least one peeling element (10) comprises cutting means (4) along substantially the whole length of its outer surface.

6. A peeling drum as claimed in any one of claims 1 to 5, characterized in that the peeling drum (7) comprises means (13) for moving a peelable product along said peeling elements (10) from a first end (5) of the peeling elements towards a second end (6) of the peeling elements.

7. A peeling device, characterized in that said peeling device (1) comprises a peeling drum (7) according to any one of the claims 1 to 6.
